(19) United States
(12) Patent Application Publication
(10) Pub. No.: US 2009/0155040 A1
(43) Pub. Date: Jun. 18, 2009

(54) Pipe Grapple Apparatus and Method

(75) Inventor: Tim Martin, Peers (CA)

Correspondence Address: THOMAS E. MALYSZKO, SUITE 700, 205 - 5 AVENUE, S.W., CALGARY, AB, T2P 2V7, CA

(73) Assignee: LEDCOR IP HOLDINGS LTD., Vancouver (CA)

(21) Appl. No.: 12/257,321

(22) Filed: Oct. 23, 2008

(30) Foreign Application Priority Data
Oct. 23, 2007 (CA) 2608453

(51) Int. Cl. B66C 1/42

(52) U.S. Cl. 414/744.8; 414/815

(57) ABSTRACT

A grappler for use in grasping and manipulating pipe segments for large diameter pipeline tie-ins has a first frame and a second frame movably secured thereto. A pair of grapple arms is pivotally mounted to each frame and is actuated between a open position and a closed position to engage and grasp the pipe segments. An actuator displaces the second frame relative to the first frame in a first degree of movement to displace one pair of grapple arms relative to the other pair of arms, and a support frame provides the grappler with two additional degrees of movement. When mounted to a backhoe or like device, the grappler facilitates safe retrieval of pipe from hazardous trenches, and provides handling and alignment of the pipe segments for easier and safer welding of the pipe joints.

### FIELD OF THE INVENTION

The present invention relates to pipe handling equipment generally, and in particular relates to a grapple device for tie-ins of large diameter pipes in pipelines typical in the oil & gas industry.

### BACKGROUND OF THE INVENTION

In typical tie-in situations the pipe lays in the ditch with an overlap of pipe at the tie-in point. When the tie-in crew arrives they use side booms to pick up the pipe and align it so that it can be marked and cut to length. When cutting off the excess pipe, a side boom is normally placed at the center of the tie-in to hang onto the piece of pipe being cut off so that it can be removed from the trench. When the excess piece of pipe is cut off, the side boom must try and maneuver in usually very tight quarters and turn 180 degrees to place the excess pipe on the side of the work area and then reposition itself to assist on the tie-in. This causes a great deal of ground disturbance by the side boom turning and it takes extra time because a tie-in crew cannot always have all of its equipment in place until this function has been done due to the space required to turn the side boom around when carrying a piece of pipe.

Once the excess pipe has been cut off, the remaining pipe section is ready to be aligned with an end of a pipe, or pipeline, under construction, and clamps are put on the weld joint to help align the pipe ends to be welded. A typical tie-in crew would achieve the line-up for welding by positioning their side booms in such a manner as to give themselves leverage to pull or lift the pipe section in a side-to-side and upward movement. An industry term for this procedure is “break-over” which means hooking the side boom far enough back from the end of a pipe section that, when lifted, the pipe section will deflect so that it will stay level or at a desired angle for alignment with the pipeline to which it will be welded. To achieve this with the use of side booms is difficult as it sometimes requires moving the side booms to different positions to get proper break over, and having the side booms place their load lines at extreme angles perpendicular to the pipe to attempt to achieve sideways movement for the final fit up so that the weld joint can be welded within industry specifications. This can be very time consuming and can cause the weld joint area to become unsafe due to stress being introduced into the weld joint from the side booms deflecting pipe to achieve a line up for welding. Conventional line-up clamps for tie-in welding are typically only 6 to 8 inches in width and are designed to hold the pipe in place for welding. If the weld joint experiences a lot of stress in achieving the line-up and the line clamps break, then the ends of the pipe have the potential to move rapidly in any direction and can potentially cause serious injury to workers in the tie-in area.

What is therefore desired is a novel pipe grappling apparatus which overcomes the limitations and disadvantages of the existing devices and pipe tie-in methods. Preferably, it should assist in large diameter pipeline tie-ins and in safe retrieval of pipe from hazardous trenches. It should facilitate the handling and alignment of pipe segments for easier and safer welding of the pipe joints. Specifically, it should provide for the gripping and manipulating of one pipe segment to bring it into alignment with another pipe segment, for gripping the other pipe segment, and for positioning, or butting-up, the ends of the pipe segments suitably for welding the resulting joint. The apparatus should have at least two degrees of movement to facilitate clamping of the apparatus onto the pipe segments, and a third degree of movement to bring the pipe segments into abutment. The apparatus should be detachably mountable to a lifting device, such as a backhoe, which itself may provide further degrees of movement to aid in pipe alignment and tie-in.

### SUMMARY OF THE PRESENT INVENTION

The grapple apparatus of the present invention, also referred to as a “Tie-in Hand”, is particularly suited to assist in pipe retrieval from hazardous trenches and in large diameter pipeline tie-ins where workers must perform difficult tasks such as aligning weld joints. Such pipelines can convey large volumes of fluids, such as oil, natural gas or other petroleum products. The grappler is designed to handle pipe segments made of various materials, such as metal, plastic or concrete for use in pipelines such as sewers and the like.

Hence, according to the present invention, there is provided in one aspect a grapple apparatus comprising:

a frame having a first frame portion and a second frame portion movably secured to the first frame portion;

a first pair of grapple arms pivotally mounted to the first frame portion about a first axis;

a second pair of grapple arms pivotally mounted to the second frame portion about said first axis;

means for actuating said grapple arms between a first open position and a second closed position for engaging and grasping an object; and,

means for displacing the second frame portion relative to the first frame portion to provide freedom of movement in the direction of the first axis to displace the first pair of grapple arms relative to the second pair of grapple arms.

### BRIEF DESCRIPTION OF THE DRAWING FIGURES

Embodiments of the invention will now be described, by way of example only, with reference to the accompanying drawings, wherein:

FIG. 1 is a perspective view of a grapple apparatus according to a preferred embodiment of the present invention wherein first and second pairs of grapple arms are in an open position prior to grasping first and second pipe segments, respectively;

FIG. 2 is an end view of a variant of the grapple apparatus of FIG. 1 showing the grapple arms in a closed position for gripping a pipe segment; and,

FIG. 3 is a longitudinal cross-sectional view through the frame of the grapple apparatus of FIG. 1 showing an internal piston for sliding a second frame portion relative to a first frame portion.

### DESCRIPTION OF PREFERRED EMBODIMENTS

The figures show a grapple apparatus, or “grappler”, according to the present invention (generally designated by reference numeral 20) for grasping and maneuvering one or more suitably shaped objects, such as the illustrated tubular first and second (i.e. left and right) pipe segments 10 and 12, respectively.

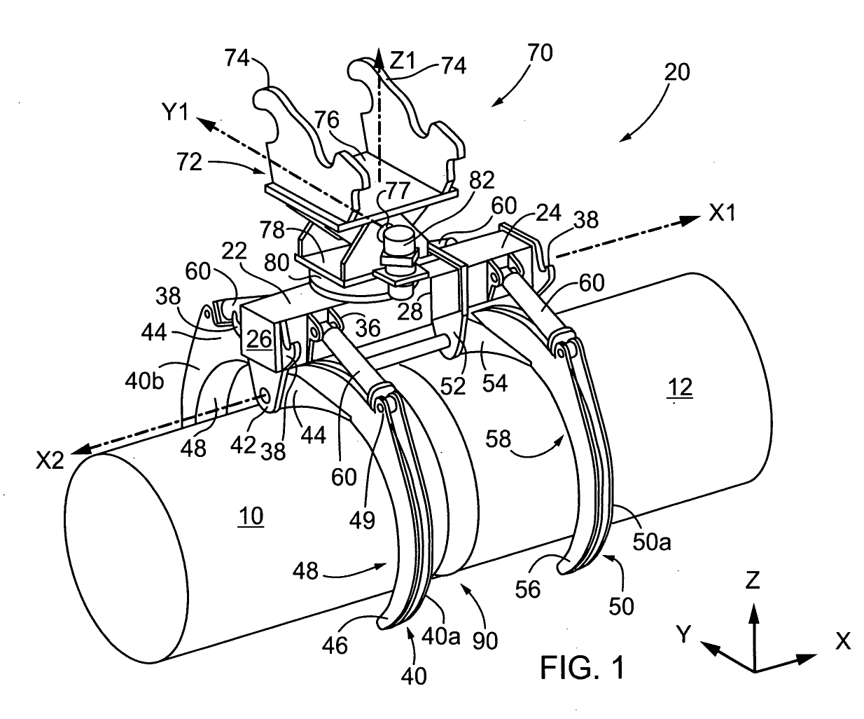

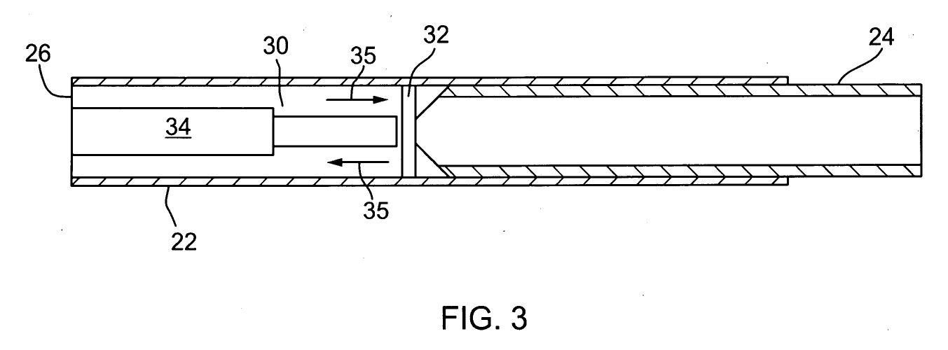

Referring specifically to FIG. 1, the grappler frame 20 has a first frame portion 22, and a second frame portion 24 movably secured to the first frame portion. The first frame portion 22, also called the “left frame” for ease of reference, has a hollow elongate housing along a longitudinal axis X1 which is capped at the left end 26 and open at the opposed right end 28 to define an accessible cavity 30 (shown in FIG. 3). The second frame portion 24, or “right frame”, has an elongate construction and an exterior shape complimentary to the left frame's cavity 30 so as to snugly and slidingly fit therewithin. Hence, the right frame may slide relative to the left frame along the axis X1. A means for displacing the right frame within the left frame is located in the cavity 30 and operatively engages both frame portions 22, 24. As seen in FIG. 3, the displacing means is preferrably in the form of an internal piston such as a hydraulic ram 34, a linear actuator, or the like, which abuts both the left end 26 of the left frame and a left end 32 of the right frame, and which is capable of both pushing or pulling the right frame within the left frame as indicated by the arrows 35. The ram 34 should be capable of remote operation by a user.

A first pair of opposed grapple arms 40a, 40b, identified collectively as 40, and sometimes referred to as tongs or a tong assembly, are pivotally mounted below the left frame on a pivot assembly 42 for rotation about a first common axis X2 (running parallel to axis X1). Similarly, a second pair of opposed grapple arms 50a, 50b (50b being hidden from view in FIG. 1), identified collectively as 50, are pivotally mounted below the right frame 24 on a pivot assembly 52 for rotation about the same first common axis X2. Each grapple arm has a first end 44, 54 coupled to the respective pivot assembly 42, 52, a free distal second end 44, 54, and an object-engaging surface 48, 58 therebetween. The surfaces 48, 58 are arcuate in the present embodiment to match the exterior profile of the objects-to-be-engaged, namely the cylindrical pipe segments 10, 12. Preferably, but optionally, the surfaces 48, 58 are lined with a cushioning material, such as neoprene, to promote uniform gripping of the pipe segments and/or to avoid damaging the pipe surfaces.

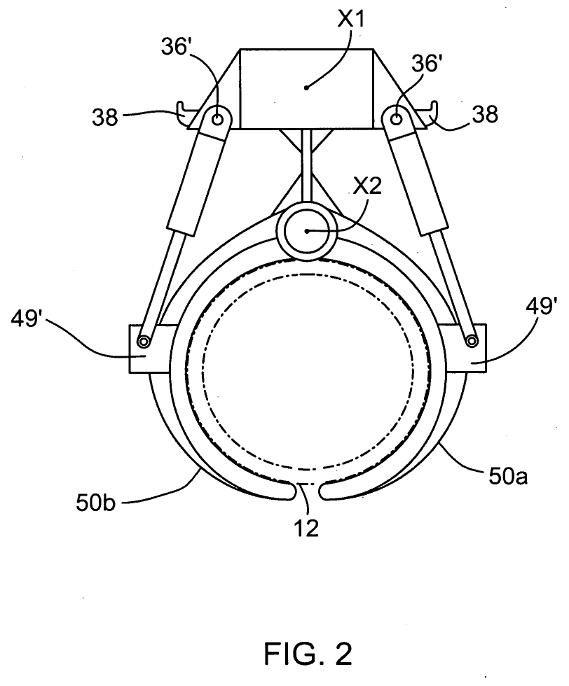

A means for actuating each pair of grapple arms 40, 50 is provided to move each of the arms between a first open position (as shown in FIG. 1) where the arms are disengaged from the object to be handled, and a second closed position (as shown in FIG. 2) where each pair of grapple arms engage and grasp the object, namely a respective pipe segment in this instance. In the preferred embodiment an actuator 60 in the form of a hydraulic ram, a linear actuator, or the like, is provided for each grapple arm. As the configuration for each grapple arm is functionally the same, grapple arm 40a will be used to illustrate the actuator structure. The respective ends of the actuator 60 are pivotally mounted at 36 to the left frame 22 and at 49 to an outer portion of the arm 40a intermediate its first and second ends 44, 46. Hence, extension of the actuator moves the arm 40a toward a closed position, and retraction of the actuator moves the arm toward the open position. In the preferred embodiment the operation of the actuators 60 is controlled remotely with one hydraulic system so that all four actuators are moved in concert, namely simultaneously, between the open and closed positions. However, it will also be appreciated that, for particular applications, the actuators may be configured to be individually and independently controlled, for instance so that the first pair of grapple arms 40 can be moved to a different grasping position than the second pair of grapple arms 50. It is also important to note that the actuators are mounted to the grapple arms and respective frame portions to permit the independent movement of the second pair of grapple arms 50 relative to the first pair of grapple arms 40 in the direction of the first common axis X1. Hence, this motion provides the grappler with a first degree of freedom, or movement.

Two additional degrees of movement are provided by a support member 70 attached to the left frame 22 having a means for rotating the frame 20 about the mutually perpendicular axes Y1 and Z1. The support member 70 has two main components. First, a pivot assembly 72 has spaced mounting members 74 suitably configured for detachable mounting to a lifting device (not shown), such as the arm or boom of a mobile material handling machine, for instance a backhoe, and has a lower plate member 78 adapted to pivot about a pin 77 centred on the axis Y1 relative to an upper plate member 76. Second, a swivel assembly 80 is operatively engaged between the lower plate member 78 and the top of the left frame 22 for rotating the entire frame 20 relative to the support member about the axis Z1, driven by a hydraulic “orbital” motor 82. The axis Z1 is oriented generally perpendicularly to the common axis X1, and in turn the axis Y1 is oriented perpedicularly to both the axies X1 and Z1. It will be appreciated that the support 70 may alternately be attached to the right frame 24 to provide substantially the same operation, but this is not preferred in the FIG. 1 embodiment as it could interfere with the sliding of the frame portions.

It will be understood that the lifting device should provide further degrees of movement. It is expected that the lifting device should be able to lift and lower the grappler along the Z axis, and to provide side-to-side motion along the XY plane (i.e. the plane formed by the X and Y axes). Further, some twisting motion about the X axis may also be possible. This is in addition to the beneficial three degrees of movement provided by the grappler along or about the X1, Y1 and Z1 axes relative to the mounting members 74, and namely the lifting device.

The inner surface 48 of each grappler arm should be made wide enough so that each pair of grappler arms can firmly grip and hold a respective pipe segment during welding of those segments. However, certain applications might require more than one pair of grappler arms to achieve a desired pipe grip, and so it should be appreciated that two or more longitudinally spaced pairs of grappler arms may be provided on one or both of the left and right frames 22, 24 in alternate embodiments.

A pair of outwardly protruding hooks 38 for supporting a pipe safety sling is provided at the left end 26 of the left frame 22 and at the opposed right end of the right frame 24.

FIG. 2 shows a variant of the grappler of FIG. 1 with the grapple arms in a closed position for gripping the pipe segment 12. It illustrates some possible variations in the grappler design, such as location of the pivot mount 49¹ closer to the distal ends on the grappler arms, and an alternate structure for the pivot mounts 36¹ and the pivot assembly 42¹.

The many advantages, operation and method of using the present invention may now be better understood.

The grappler is first operatively connected to a backhoe (or other lifting device) by connecting the mounting members 74 to the backhoe's arm, and by connecting all three of the grappler's hydraulic systems, namely one for each of the internal ram 34, the actuators 60 and the orbital motor 82, to the backhoe's hydraulics for operation therefrom. It is understood that some or all of the grappler hydraulics may be connected to an alternate hydraulic system for remote operation from a location other than the backhoe, but this is not the case for the present example. With the grappler mounted on the backhoe, the backhoe can then position itself at the tie-in point and maneuver the grappler so that both pairs of grapple arms 40, 50, in the open position, are placed over a segment of pipe in a trench (as discussed in the Background) and are then actuated into the closed position to grasp an “excess” portion of the pipe segment to be cut off. Once cut off, the backhoe lifts the grappler which is holding the excess (cut-off) piece of pipe and simply spins around to place the excess pipe out of the way of the trench. This twisting may be advantageously facilitated by the grappler's freedom of movement about the Z1 axis. No moving of other equipment is needed for this task, unlike prior art methods.

Once the excess pipe has been cut off and removed, the remaining pipe (shown as the left pipe segment 10 in FIG. 1) is ready to be aligned with an end of the adjacent pipeline under construction (shown as the right pipe segment 12 in FIG. 1). The left and right pipe segments are placed in line-up clamps which straddle the desired weld joint and help align the pipe ends to be welded. The grappler 20 is then placed centered over the desired weld joint (as illustrated in FIG. 1) and each pair of grapple arms 40, 50 are actuated to move from an open to a closed position to clamp onto the respective pipe segments 10, 12 on each side of the desired weld joint (general location indicated by 90). With the grappler's freedom of movement in multiple directions, and those of the backhoe, the placement of side booms for break-over should not be as critical as previously without the grappler due to the present arrangement's ability to lift or push down on the pipe segments in a safe manner. Hence, although side booms are still needed, fewer may be required. To achieve a side-to-side line up, the side booms will not have to place the load lines at unsafe angles because the grappler has the ability to move the gripped pipe segments in a straight side-to-side motion along the axis X1 right at the weld joint. If stress is introduced into the weld joint to achieve a line-up, then the workers on the tie-in will have the added safety factor of having the grappler attached to the pipe segments to keep them secure. Once the weld joint is complete, the grapple arms are released and the grappler is available to help prepare the next pipe segment for welding to the pipeline.

Among other advantages, the grappler should advantageously take the place of at least one side boom on a normal tie-in crew, and in addition increase safety and productivity of tie-in jobs. The grappler should provide a lifting device with the ability to reach into hazardous trenches or ditches, grab pipe sections that are in the ditch, and lift them out, and to further to assist in a tie-in without the need for a worker to go into the ditch to hook onto the pipe. Hence, the grappler is suited to hold a single piece of pipe with one or both sets of grapple arms, or to maneuver two pipe segments simultaneously as shown in FIG. 1.

It is noted that the hydraulic system with which the grappler communicates, whether on the lifting device carrying the grappler or other such system, should be equipped with lock out valves or the like so that the grappler's hydraulically operated components do not move during welding operations.

The above description is intended in an illustrative rather than a restrictive sense, and variations to the specific configurations described may be apparent to skilled persons in adapting the present invention to other specific applications. Such variations are intended to form part of the present invention insofar as they are within the spirit and scope of the claims below.

We claim:

1. A grapple apparatus comprising:
a frame having a first frame portion and a second frame portion movably secured to the first frame portion;
a first pair of grapple arms pivotally mounted to the first frame portion about a first axis;
a second pair of grapple arms pivotally mounted to the second frame portion about said first axis;
means for actuating said grapple arms between a first open position and a second closed position for engaging and grasping an object; and,
means for displacing said second frame portion relative to said first frame portion to provide a degree of movement in the direction of said first axis to displace said first pair of grapple arms relative to said second pair of grapple arms.

2. The apparatus of claim 1 further comprising a support member attached to said frame for detachably mounting said frame to a lifting device, said support member having a means for rotating said frame to provide two additional degrees of movement.

3. The apparatus of claim 2 wherein said means for rotating comprises a pivot assembly for pivoting said frame about a second axis disposed generally perpedicularly to said first axis, and a swivel assembly for rotating said frame about a third axis disposed generally perpedicularly to said second axis.

4. The apparatus of claim 3 wherein said swivel assembly is motorized for remote control of rotation about said second axis.

5. The apparatus of claim 1 wherein said second frame is slideably mounted within a cavity of said first frame, and said means for displacing is located within said cavity for sliding said second frame relative to said first frame.

6. The apparatus of claim 5 wherein said means for displacing is operatively engaged with an end of said second frame disposed within said cavity and comprises one of a hydraulic ram and a linear actuator.

7. The apparatus of claim 1 wherein said means for actuating comprises an actuator for each grapple arm, one end of said actuator being pivotally mounted to said grapple arm and another end of said actuator being pivotally mounted to a respective first or second frame portion.

8. The apparatus of claim 7 wherein said actuators are simultaneously or individually remotely controlled for grasping and releasing said object with the grapple arms.

9. The apparatus of claim 8 wherein each actuator comprises one of a hydraulic ram and a linear actuator.

10. The apparatus of claim 1 wherein each grapple arm has an arcuate object-engaging surface lined with a cushioning material.

11. A method for manipulating an object with a grapple apparatus having a frame with a first frame portion and a second frame portion movably secured to said first frame portion, a first pair of grapple arms pivotally mounted to said first frame portion about a first axis, a second pair of grapple arms pivotally mounted to said second frame portion about said first axis, and a support member attached to said frame for detachably mounting said frame to a lifting device, said method comprising moving said grapple arms between a first open position and a second closed position to engage and grasp said object, and moving said grapple apparatus in three degrees of movement.

12. The method of claim 11 wherein one aspect of said three degrees of movement comprises displacing said second frame portion relative to the first frame potion in the direction of said first axis, thereby displacing said first pair of grapple arms relative to said second pair of grapple arms.

13. The method of claim 11 wherein one aspect of said three degrees of movement comprises pivoting said frame about a second axis disposed generally perpedicularly to said first axis.

14. The method of claim 12 wherein another aspect of said three degrees of movement comprises pivoting said frame about a second axis disposed generally perpedicularly to said first axis using a pivot assembly.

15. The method of claim 11 wherein one aspect of said three degrees of movement comprises rotating said frame about a third axis disposed generally perpedicularly to said first axis.

16. The method of claim 12 wherein another aspect of said three degrees of movement comprises rotating said frame about a third axis disposed generally perpedicularly to said first axis using a swivel assembly.

17. The method of claim 13 wherein another aspect of said three degrees of movement comprises rotating said frame about a third axis disposed generally perpedicularly to said first axis using a swivel assembly.

18. The method of claim 14 wherein another aspect of said three degrees of movement comprises rotating said frame about a third axis disposed generally perpedicularly to said first axis using a swivel assembly.
